(19) United States
(12) Patent Application Publication
(10) Pub. No.: US 2024/0403636 A1
(43) Pub. Date: Dec. 5, 2024

(54) SELF-ATTENTION BASED NEURAL NETWORKS FOR PROCESSING NETWORK INPUTS FROM MULTIPLE MODALITIES

(71) Applicant: GOOGLE LLC, Mountain View, CA (US)

(72) Inventors: Valerii Likhosherstov, Cambridge (GB); Mostafa Dehghani, Amsterdam (NL); Anurag Arnab, Grenoble (FR); Krzysztof Marcin Choromanski, Lincroft, NJ (US); Mario Lucic, Adliswil (CH); Yi Tay, Singapore (SG)

(21) Appl. No.: 18/697,257

(22) PCT Filed: Oct. 5, 2022
(86) PCT No.: PCT/US2022/045805

§ 371 Date: Mar. 29, 2024

Related U.S. Application Data
(60) Provisional application No. 63/252,593, filed on Oct. 5, 2021.

(51) Int. Cl. G06N 3/08; G06N 3/045

(52) U.S. Cl. CPC G06N 3/08; G06N 3/045

(57) ABSTRACT

Methods, systems, and apparatus, including computer programs encoded on computer storage media, for executing and training a multi-modal, multi-task self-attention neural network.

### CROSS-REFERENCE TO RELATED APPLICATIONS

This application claims the benefit of priority to U.S. Provisional Application Ser. No. 63/252,593, filed Oct. 5, 2021, the entirety of which is incorporated herein by reference.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates network outputs for received network inputs using a multi-modal, multi-task neural network.

That is, the neural network can be used to perform multiple different machine learning tasks for inputs from multiple different modalities.

In particular, the neural network includes a set of shared self-attention layers that are shared between tasks and modalities. The neural network can also include modality-specific layers, task-specific layers, or both.

Particular embodiments of the subject matter described in this specification can be implemented so as to realize one or more of the following advantages.

Using techniques described in this specification, a system can train and execute a single neural network that is configured to process respective input sequences corresponding to multiple different modalities using self-attention. By co-training the neural network using machine learning tasks corresponding to the different modalities, a training system can achieve higher performance on each task than if the neural network were trained using a single task or a single modality.

By processing respective inputs corresponding to different modalities, the neural network can learn to generate feature representations of the inputs that generalize across multiple domains. As a particular example, by processing inputs representing images, the neural network can learn to generate feature representations that are also useful when processing inputs representing audio data.

Training the same neural network for different modalities can further improve the efficiency of training. For example, the number of training steps required to train the neural network for multiple modalities can be significantly fewer than the total number of training steps required to train respective neural networks for different tasks and modalities, so that the time and computational cost required to train the neural network is less than the time and computational cost required to train multiple respective neural networks.

As another example, compared to training separate neural networks for each task corresponding to each modality, training the single neural network requires fewer total network parameters to be learned. As a particular example, in some implementations in which the neural network is configured to execute n different tasks, the techniques described in this specification can reduce the number of network parameters required to be learned by approximately a factor of n. In some implementations, the reduced number of parameters can further allow the neural network to be deployed in resource-constrained environments after training. For instance, the neural network can be deployed on an edge device, e.g., a mobile phone or tablet computer, that has limited computational and memory resources that would otherwise have made it infeasible to deploy n different trained neural networks on the edge device.

A neural network configured to process input sequences from multiple modalities can further have improved time, memory, and/or computational efficiency at inference time compared with a neural network trained for a single task or modality. For example, in some implementations, for an input sequence corresponding to any given task and/or modality, the neural network can activate only a strict subset of its network parameters to process the input sequence. As a particular example, as described above, the neural network can include one or more task-specific network blocks and/or one or more modality-specific network blocks. Thus, the neural network can perform fewer computations for each input because only a subset of the network blocks are used. These efficiency gains can be particularly important on edge devices that may have limited computational resources available.

In some implementations described in this specification, a system can train the neural network without requiring any additional hyperparameter tuning relative to a single-task, single-modality neural network, further improving training efficiency.

As described in this specification, a self-attention based neural network configured to process inputs from respective modalities, e.g., inputs that includes one or more images, videos, and/or audio sequences, can require far fewer computations to achieve the same performance as a state-of-the-art convolutional neural network. That is, for a fixed compute budget, the self-attention based neural network performs better than the convolutional neural network. This is because applying self-attention is generally more computationally efficient than convolving a kernel across an entire sequence, as the self-attention mechanism is able to attend to different regions of the sequence with fewer computations than convolution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for training the neural network.

FIG. 3 illustrates different schemes for training the neural network on multiple tasks.

FIG. 4 is a flow diagram of an example process for generating a network output using the neural network.

Like reference numbers and designations in the various drawings indicate like elements.

### DETAILED DESCRIPTION

This specification describes systems implemented as computer programs on one or more computers in one or more locations that can perform multiple different tasks using a self-attention based neural network.

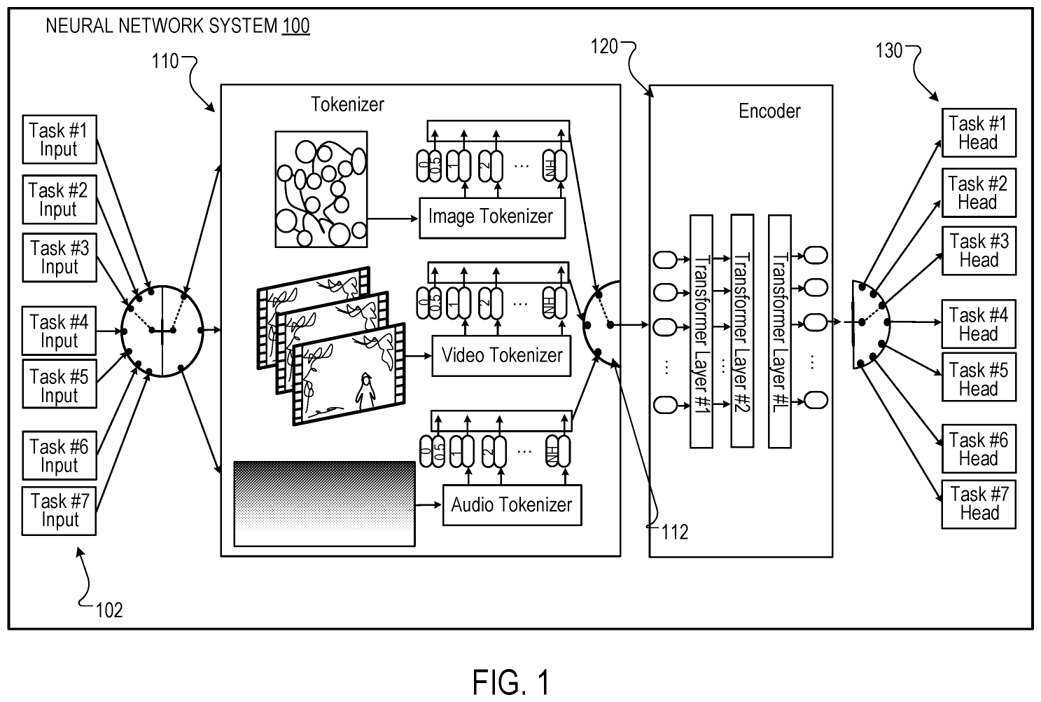

FIG. 1 shows an example neural network system 100. The neural network system 100 is an example of a system implemented as computer programs on one or more computers in one or more locations, in which the systems, components, and techniques described below can be implemented.

This system 100 executes a self-attention based neural network that has been configured through training to process a network input from one of multiple different modalities and to generate a network output that characterizes the network input.

A self-attention based neural network is a neural network that includes one or more self-attention neural network layers. A self-attention neural network layer receives as input a sequence of layer input elements and applies an attention mechanism over the sequence of layer input elements to generate a sequence of layer output elements. In particular, for each input element, the self-attention neural network layer applies the attention mechanism over the sequence of layer input elements using one or more queries derived from the input element to generate a respective output element. Some self-attention neural network layers are multi-head self-attention neural network layers. A multi-head self-attention neural network layer applies h different attention mechanisms in parallel to generate respective sequences of output elements, and then combines the multiple sequences of output elements to generate a final sequence of output elements.

Self-attention mechanisms are described in more detail below.

The self-attention based neural network is configured to process respective network inputs 102 corresponding to each of multiple modalities.

In this specification, a “modality” characterizes a mode by which data can be represented, and can define a class of network inputs that each represent data according to the mode.

For example, the multiple modalities can include an “image” modality, where the network inputs corresponding to the image modality include or represent one or more images.

As another example, the multiple modalities can include a “video” modality, where the network inputs corresponding to the video modality include or represent one or more videos.

As another example, the multiple modalities can include an “audio” modality, where the network inputs corresponding to the audio modality include or represent one or more audio samples.

For each modality, the self-attention based neural network can be configured to generate and process input sequences corresponding to the modality to perform one or more machine learning tasks corresponding to the modality.

For example, the one or more machine learning tasks corresponding to each modality may comprise a classification task.

For instance, where the modalities include an image modality, the system may process the pixels of images included in or represented by the network input corresponding to the image modality to generate an input sequence corresponding to the image modality. The system may process the input sequence to generate a predicted network output which comprises an image classification output that includes a respective score corresponding to each of a plurality of categories.

Where the modalities include a video modality, the system may process the pixels of one or more image frames included in the network input corresponding to the video modality to generate an input sequence corresponding to the video modality. The system may process the input sequence to generate a predicted network output, which may comprise a video classification output, or a video frame classification output. The video (or video frame) classification output may include a respective score corresponding to each of a plurality of categories.

Where the modalities include an audio modality, the system may process the audio samples included in the network input corresponding to the audio modality to generate an input sequence corresponding to the audio modality. The system may process the input sequence to generate a predicted network output which comprises an audio classification output that includes a respective score corresponding to each of a plurality of categories.

In some examples, the modalities include one of an image modality, a video modality or an audio modality, and the one or more machine learning tasks comprise a classification task for that modality. In some examples, the modalities include two of an image modality, a video modality or an audio modality, and the one or more machine learning tasks comprise a classification task for each of those two modalities (e.g. the two modalities may comprise a video modality and an audio modality). As another specific example, the modalities may include an image modality, a video modality and an audio modality. In this case, the one or more machine learning tasks may comprise an image classification task, a video (or video frame) classification task and an audio classification task.

Other machine learning tasks are also possible for various modalities. For instance, for an input sequence representing one or more images, the self-attention based neural network can process the input sequence to perform one or more image processing machine learning tasks.

Example machine learning tasks are further discussed below.

The self-attention based neural network processes each input sequence, regardless of the modality or machine learning task corresponding to the input sequence, using one or more shared neural network layers 120.

The shared neural network layers 120 include one or more self-attention neural network layers. For example, the self-attention based neural network can include a sequence of self-attention network blocks (also referred to as “Transformer layers”) that each include one or more self-attention neural network layers, where the input for each self-attention network block is the output of the previous block in the sequence. In the example of FIG. 1, the shared layers 120 include a sequence of L Transformer layers.

Generally, the self-attention based neural network also includes one or more modality-specific neural network layers that are configured to process only input sequences (or intermediate representations of input sequences generated by previous neural network layers in the self-attention based neural network) corresponding to a particular modality of the multiple modalities.

In some implementations, the self-attention based neural network can include one or more task-specific neural network layers that are configured to process only input sequences (or intermediate representations thereof) corresponding to a particular task of a particular modality of the multiple modalities.

That is, the neural network can include the shared layers 120, one or more modality-specific layers, and one or more task-specific layers.

In particular, before and/or after the sequence of self-attention network blocks and for each of the multiple modalities, the self-attention based neural network can include one or more modality-specific network blocks that include one or more modality-specific neural network layers for the modality.

The modality-specific network blocks for each modality can be at the same location in the architecture of the self-attention based neural network, such that when the preceding neural network layer in the architecture generates a layer output corresponding to an input sequence having a particular modality, the self-attention based neural network can determine to provide the layer output to the modality-specific network block corresponding to the particular modality. Then, when the modality-specific network block generates a block output, the self-attention based neural network can provide the block output to the same subsequent neural network layer regardless of the particular modality.

Similarly, before and/or after the sequence of self-attention network blocks and for each machine learning task corresponding to each modality, the self-attention neural network can include one or more task-specific network blocks that include one or more task-specific neural network layers for the task. The task-specific network blocks for each task of each modality can be at the same location in the architecture of the self-attention based neural network, as described above.

As particular examples, the modality-specific network blocks can include input network blocks 110 configured to generate and process the input sequences, and the task-specific network blocks can be output network blocks 130 configured to generate the network outputs for the input sequences.

That is, the neural network can include a respective input network block 110 (also referred to as a “tokenizer”) for each modality and can include a respective output network block 130 (also referred to as a “task head”) for each task.

In some such implementations, a majority of the network parameters of the self-attention based neural network are shared across the modalities, i.e., are in the shared neural network layers 120. As particular examples, more than 50%, more than 60%, more than 70%, more than 80%, or more than 90% of the network parameters of the self-attention based neural network can be shared across all modalities.

Optionally, the neural network can also include one or more modality-specific self-attention layer blocks that receive as input the sequence generated by the tokenizer for the modality and generate an output that is consumed as input by the first shared self-attention block.

Thus, the self-attention based neural network can benefit significantly from co-training across the modalities, as the shared network parameters can learn to extract meaningful information from network inputs corresponding to any of the modalities.

Given an input data object corresponding to a particular modality, the self-attention based neural network can generate an input sequence 112 using the tokenizer 110 for the modality and then process the input sequence 112 using the shared neural network layers 120 to generate an output sequence 122.

The task head 130 corresponding to the task to be performed on the input data object can then process the output sequence 122 to generate the output for the task. For example, each task head 130 can include one or more fully-connected layers that are configured to process the output sequence 122 or, more concretely, one or more of the embeddings in the output sequence 122, to generate the output for the task.

In particular, given an input data object of a particular modality, the tokenizer 110 for the modality can generate the input sequence 112 by determining multiple patches of the input data object, where each patch includes a different subset of the elements of the data object.

For example, given an input image corresponding to the image modality, the self-attention based neural network can determine respective image patches that each include a subset of the pixels of the image.

As another example, given input video corresponding to the video modality, the self-attention based neural network can generate video patches that each include: one or more frames of the video, a subset of the pixels of a single frame of the video, or a temporal slice of the video that includes a subset of pixels from each of multiple frames of the video.

As another example, given an input audio sample corresponding to the audio modality, the self-attention based neural network can determine respective audio patches that each include a subset of the time steps of the audio sample.

The tokenizer 110 can then process the patches of the input data object to generate an input sequence that includes a respective input element at each of multiple input positions. Each of one or more of the input positions can correspond to a respective different patch of the input data object.

For example, the tokenizer 110 can generate, for each patch of the data object, a one-dimensional input element that includes the elements of the patch. As a particular example, if each patch is an image patch that has dimensionality L×W×C, where C represents the number of channels of the image (e.g., (=3 for an RGB image), then the system can generate an input element in the input sequence that has dimensionality 1×(L·W·C).

As another example, the tokenizer 110 can generate, for each patch of the data object, a one-dimensional initial input element as described above. The tokenizer 110 can then use an embedding neural network that processes the initial input element to generate an embedding of the initial input element. For example, the embedding neural network can include one or more feedforward neural network layers that project the initial input into an embedding space.

In some implementations, the tokenizer 110 can determine the embedding of the initial input element to be an input element in the input sequence 112.

In some other implementations, the tokenizer 110 can combine the initial input element with a positional embedding of the initial input element to generate an input element in the input sequence. The positional embedding represents the position within the data object of the patch corresponding to the initial input element. In some implementations, the positional embedding corresponding to each patch of the data object can be an integer. For example, a first image patch at the top left of an input image can have a positional embedding of ‘l’, a second image patch immediately to the right of the first image patch has a positional embedding of ‘2’, and so on. In some other implementations, the positional embeddings are machine-learned. For example, during the training of the self-attention based neural network, a training system can concurrently learn the positional embeddings by backpropagating an error of the self-attention based neural network through the self-attention based neural network and to the positional embeddings.

In some implementations, one or more of the input elements in the input sequence 112 do not correspond to any patch of the data object. As a particular example, the input sequence 112 can include one machine-learned input elements (also referred to as a “class” token); e.g., the first input element and/or the last input element of the input sequence can be a machine-learned input element. For example, during the training of the self-attention based neural network, a training system can concurrently learn the one or more machine-learning input elements by backpropagating an error of the self-attention based neural network through the self-attention based neural network and to the machine-learning input elements. In implementations in which the input elements corresponding to respective patches include positional embeddings, the tokenizer 110 can add a positional embedding to the machine-learned input elements as well, e.g., a machine-learned positional embedding or a positional embedding of all-zeros. When the input sequence 112 includes a class token, the output head can process the embedding corresponding to the class token in the output sequence to generate the output for the task.

After generating the input sequence 112 corresponding to a respective data object, the self-attention based neural network can process the input sequence 112 using the shared layers 120 to generate an output sequence 112, and then process the output sequence 122 using the head 130 corresponding to the appropriate task to generate a network output that characterizes the respective data object for the task.

In the example of FIG. 1, the neural network is configured to process inputs of three different modalities: image, audio, and video. More specifically, the neural network is configured to perform tasks 1, 2, and 3 on images, tasks 4 and 5 on videos, and tasks 6 and 7 on audio.

More generally, however, the neural network can be configured to perform any appropriate set of machine learning tasks corresponding to any appropriate set of modalities.

Some specific examples follow.

For example, at least one of the machine learning tasks may be a speech recognition task, where the neural network is configured to process a representation of an audio waveform to generate an output that characterizes a sequence of phonemes, characters, or words corresponding to the audio waveform.

As another example, at least one of the machine learning tasks may be a video analysis task, where the neural network is configured to process a sequence of video frames to generate an output that characterizes the video frames, e.g., by characterizing whether the video frames depict a person performing a particular action.

As another example, at least one of the machine learning tasks may be a natural language processing task, where the neural network is configured to process a portion of text to generate an output that characterizes the portion of text, e.g., by characterizing a translation of the portion of text into a different natural language.

As another example, at least one of the machine learning tasks may be an image processing task, where the neural network is configured to process an input that includes an image to generate a corresponding output, e.g., a classification output, a regression output, or a combination thereof.

The neural network can be configured to process images of any appropriate type, e.g., RGB images, LIDAR images (e.g., point clouds), and so on. The neural network can be configured to process the images to perform any appropriate image processing task, e.g., a classification task, a regression task, or a combination thereof.

In particular, in this specification, processing an image refers to processing the intensity values of the pixels of the image.

As a particular example, the neural network can be configured to generate a classification output that includes a respective score corresponding to each of multiple categories. The score for a category indicates a likelihood that the image belongs to the category. In some cases, the categories may be classes of objects (e.g., dog, cat, person, and the like), and the image may belong to a category if it depicts an object included in the object class corresponding to the category. In some cases, the categories may represent global image properties (e.g., whether the image depicts a scene in the day or at night, or whether the image depicts a scene in the summer or the winter), and the image may belong to the category if it has the global property corresponding to the category.

As another particular example, the neural network can be configured to generate an element-level classification output (e.g., a pixel-level classification output for an RGB image or a point-level classification output for a LIDAR image) that includes, for each element in the image, a respective score corresponding to each of multiple categories. For a given element (e.g., for a given pixel or point), the score for a category indicates a likelihood that element belongs to the category. In some cases, the categories may be classes of objects, and an element may belong to a category if it is part on an object included in the object class corresponding to the category. That is, the element-level classification output may be semantic segmentation output.

As another particular example, the neural network can be configured to generate a regression output that estimates one or more continuous variables (i.e., that can assume infinitely many possible numerical values) that characterize the image. In a particular example, the regression output may estimate the coordinates of bounding boxes that enclose respective objects depicted in the image. The coordinates of a bounding box may be defined by (x, y) coordinates of the vertices of the bounding box.

In some implementations, the neural network can be configured to process multiple images, e.g., multiple frames of a video. For example, the neural network can receive multiple images that are video frames of a video, and can process each video frame as described above to generate an output that characterizes the video frames, e.g., by characterizing whether the video frames depict a person performing a particular action.

In some such implementations, the neural network processes each video frame at respective different time points to generate a respective network output for each video frame that characterizes a prediction for the video frame. For example, the neural network can generate a network output that predicts a classification of the video frame. In some such implementations, the neural network combines the multiple network outputs corresponding to respective video frames to generate a final network output that characterizes the video. For example, the neural network can process the respective network outputs using a downstream neural network, e.g., a recurrent neural network.

In some other implementations, the neural network processes each video frame in parallel to generate a single network output that characterizes the video. As a particular example, the system can generate one or more respective input elements in the input sequence for each video frame.

Prior to using the neural network to perform one or more of the tasks, the system 100 or another training system trains the neural network on training data for the tasks, i.e., so that the neural network can effectively perform multiple tasks on data from multiple different modalities.

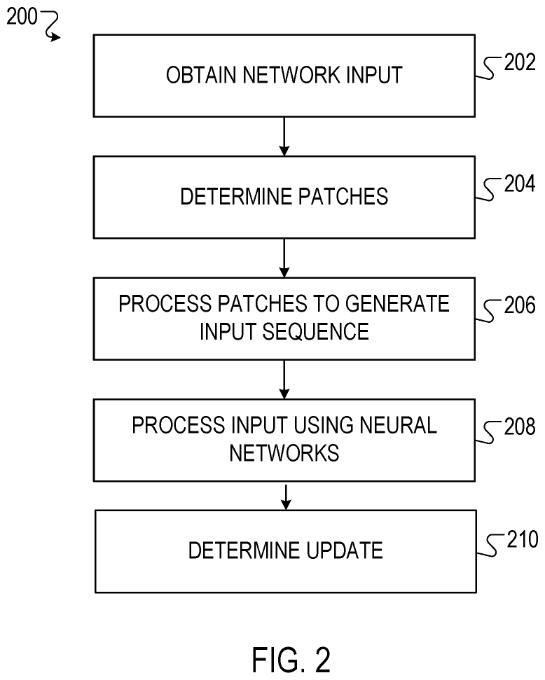

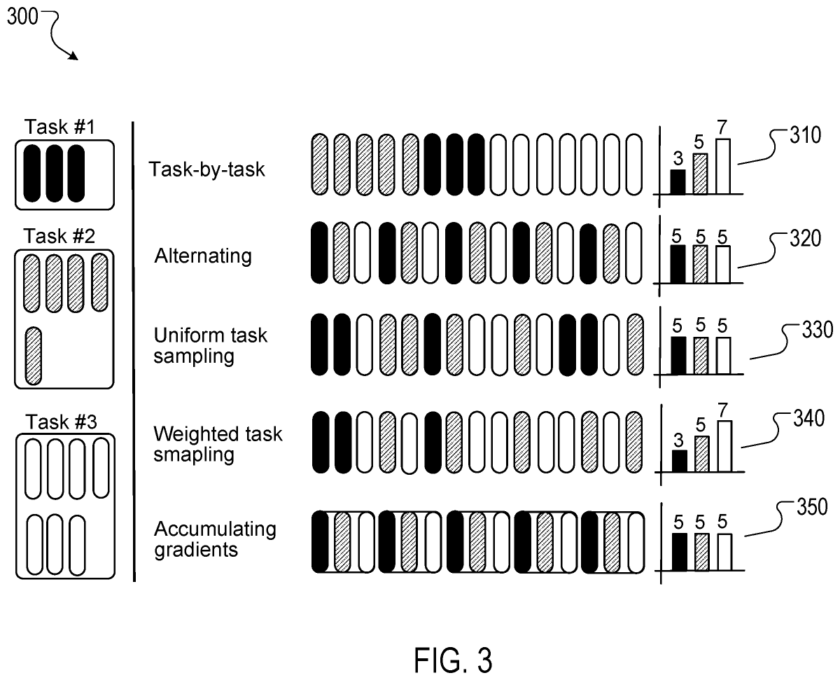

Training the neural network will be described below with reference to FIGS. 2 and 3.

After training, the self-attention based neural network can be deployed in any appropriate setting.

In some implementations, when the trained self-attention based neural network is deployed, the self-attention based neural network is configured to process input sequence corresponding to only a single particular modality of the multiple modalities for which the self-attention based neural network was trained. For example, the modality-specific network blocks corresponding to the other modalities, and/or the task-specific network blocks corresponding to respective tasks of the other modalities, can be removed from the architecture of the self-attention based neural network, leaving only the shared network blocks and, optionally, the modality-specific network blocks and task-specific network blocks corresponding to the particular modality. In some such implementations, the deployed self-attention based neural network is configured to perform only a single task of the multiple tasks corresponding to the particular modality for which the self-attention based neural network was trained.

In some other implementations, the deployed self-attention based neural network is configured to process respective input sequences corresponding to each of the multiple modalities. That is, the self-attention based neural network can be deployed in an environment, e.g., in a data center or on an edge device, in which the self-attention based neural network will receive respective input sequences corresponding to each modality, and can perform each of the one or more machine learning tasks corresponding to the modality for which the self-attention based neural network was trained.

As a particular example, after training, client devices can interact with the system 100 through an application programming inference (API), e.g., a web-based API. In particular, client devices can submit an API call that includes or identifies a network input to be analyzed and the system 100 can provide, in response, data identifying the network output for the input. For example, the system 100 can format the object detection output in a specified format, e.g., as a JavaScript Object Notation (JSON) file or as a file in another type of data-interchange format, and provide the file in response to the API call.

FIG. 2 is a flow diagram of an example process 200 for training the neural network. For convenience, the process 200 will be described as being performed by a system of one or more computers located in one or more locations. For example, a neural network system, e.g., the neural network system 100 of FIG. 1, appropriately programmed, can perform the process 200.

The system can repeatedly perform iterations of the process 200 on different batches of training examples to update the parameters of the neural network, i.e., of the tokenizer, the shared layers, and the neural network heads.

That is, at each iteration of the process 200, the system obtains a batch of one or more training examples, e.g., by sampling the batch from a larger set of training data, and uses the batch of one or more training examples to update the parameters of the neural network system.

The system can continue performing iterations of the process 200 until termination criteria for the training of the neural network have been satisfied, e.g., until the parameters have converged, until a threshold amount of wall clock time has elapsed, or until a threshold number of iterations of the process 200 have been performed.

Each training example includes a training input of a corresponding modality and a target output for one of the multiple tasks to be performed on inputs of the corresponding modality.

In some implementations, the system selects the batch so that each training input in the batch is of the same modality and each training example is for the same task.

In some other implementations, the system selects the batch so that different examples can be for different ones of the multiple tasks.

Example techniques for selecting a batch training examples from a training data set that includes training examples for multiple different tasks is described below with reference to FIG. 3.

At each iteration of the process 200, the system performs steps 202-210 for each training example in the batch.

The system obtains a network input corresponding to a particular modality and having a plurality of elements (step 202).

The system determines a plurality of patches of the network input (step 204). Generally, each patch includes a different subset of the elements of the network input.

The system processes the plurality of patches to generate an input sequence that has a respective input element at each of a plurality of input positions, where some or all of the input elements correspond to respective different patches (step 206). In particular, the system can use the input network block (the “tokenizer”) of the neural network to process the patches to generate the input sequence.

The system processes the input sequence using the neural network to generate, for at least one of the one or more machine learning tasks corresponding to the particular modality, a respective predicted network output (step 208).

As described above, the neural network has one or more self-attention neural network layers that are each configured to apply a self-attention mechanism to the input sequence or an intermediate representation of the input sequence. Additionally, at least a subset of the self-attention neural network layers are shared across the plurality of modalities. For example, the neural network can include only shared self-attention layer blocks or one or more modality-specific self-attention layer blocks followed by a set of shared self-attention blocks that are shared between all of the modalities.

The system then determines an update to a plurality of parameters of the neural network according to an error in the respective predicted network outputs (step 210).

When the task requires a classification output, the error can be a cross-entropy loss or other appropriate classification loss.

When the task requires a regression output, the error can be a mean-squared error loss or other appropriate regression loss.

In particular, the system can compute a gradient of the error with respect to the parameters of the neural network for each training example in the batch and can combine, e.g., average or sum, the gradients to determine a combined gradient. The system can then apply an optimizer to the combined gradient and the current values of the parameters to generate updated values of the parameters.

Generally, for any given input, the gradient will only be non-zero for the components that correspond to the modality of the input, the shared network blocks, and the components that correspond to the task that was performed on the input.

In other words, for each modality of the multiple modalities, the training system can process training network inputs corresponding to the modality to generate, for each of one or more of the machine learning tasks corresponding to the modality, respective predicted network outputs. The training system can then determine an error in the respective predicted network outputs of the machine learning tasks, and determine an update to the network parameters of the self-attention based neural network according to the error, e.g., using backpropagation and gradient descent. Typically, for a given machine learning task and given modality, the training system only determines an update to the network parameters that process input sequences corresponding to the given task and given modality. For example, if the self-attention based neural network includes respective modality-specific network blocks for each modality, the training system can only determine an update to the parameters of the modality-specific network block corresponding to the modality of the input sequence (and the network parameters that are shared across all modalities, e.g., the parameters of the self-attention network blocks).

When determining the parameter update corresponding to a particular modality or a particular task, the training system can identify a set of predetermined training hyperparameters that corresponds to the particular modality or particular task. For example, for each modality or for each task, the training system can identify a respective different learning rate, number of warmup steps, initialization of the network parameters, training steps, momentum, Adam hyperparameters, and so on. In other words, throughout the training of the self-attention based neural network, the training system can change the hyperparameters according to the modality or task for which the training system is processing training network inputs. Moreover, the system may not need to perform a hyperparameter search to determine the values of these hyperparameters, and can instead re-use values for the hyperparameters that were used in training a corresponding single task neural network, i.e., that were generated as the output of a hyperparameter search prior to the training of the corresponding single task neural network.

FIG. 3 shows example schemes for selecting batches of training examples from a training data set.

In particular, FIG. 3 shows example schemes for selecting batches of training examples when the training data set includes training examples for three tasks: three batches of examples from task #1, five batches of examples from task #2, and seven batches of examples from task #3. That is, the training data set is a “large” training data set that is composed of individual training data sets for each of the three tasks.

In the example of FIG. 3, each task corresponds to a different modality. In some other examples, however, one or more of the modalities can have more than one corresponding task.

At each iteration of the process 200 described above, the system selects a batch of training examples from the larger training data set and uses the batch to train the neural network, i.e., to update the parameters of the neural network.

The system can select the batch of training examples for each iteration of the process 200 from the larger training data set in any of a variety of ways.

In some implementations, during training, the system can sample batches according to the size of the corresponding training data sets from which the batches were generated, i.e., the respective sizes of the corresponding training data sets for each of the tasks. That is, the system samples batches based on the size of the corresponding training data sets for the multiple tasks. Thus, the system will train the neural network more frequently on batches for tasks that have a larger amount of training data.

One example of this is referred to in FIG. 3 as “task-by-task” training 310. In task-by-task training, the system randomly orders the tasks, and then proceeds to train the neural network on the tasks according to the order. When training the neural network on a given task, the system trains the neural network on all of the batches of training data for that task before proceeding to the next task (or, for the last task in the order, terminating training). Thus, in the example of FIG. 3, the system will train the neural network on all 5 batches from task 2, then on all 3 batches from task 1, and then on all 7 batches from task 3. However, this mode of training can result in catastrophic forgetting, where earlier tasks are “forgotten” in favor of later tasks in the order.

To assist in preventing this catastrophic forgetting, another example of this is referred to in FIG. 3 as “weighted task sampling” training 340. In this training scheme, at each training step, the likelihood that the batch selected for that training step is, for each task, based on the number of batches in the training data for the task relative to the total number of batches for all of the tasks. For example, the likelihood can be equal to the number of batches for the task divided by the total number of training batches. The system can implement this scheme in a manner that ensures that the number of training steps for any task j is equal to Uⱼ/U, where U is the total number of batches for all of the tasks, and Uⱼ is the total number of batches for task j. For example, this can be done by randomly by randomly permuting an array with U elements, where the array includes Uⱼ elements for each task j.

In some other implementations, during the training, the system determines the same number of updates to the plurality of parameters of the neural network for each of the plurality of tasks. That is, the system selects the batches so that the neural network is trained on the same number of batches for teach of the tasks, regardless of the size of the training data sets for the tasks. In other words, in the example of FIG. 3, when training for 15 iterations, the system trains on 5 batches of each of the tasks, even though task 3 has a larger training set than task 2 and task 1.

One example of this scheme is referred to as “alternating” training 320. In alternating training, the system alternates between tasks in a fixed, repeating order so that the same number of batches for each task are used for the training.

Another example of this scheme is referred to in FIG. 3 as “uniform task sampling” training 330. In this training scheme, at each training step, the likelihood that the batch selected for that training step corresponds to any given task is the same for all of the tasks, i.e., is equal to one divided by the total number of tasks T. The system can implement this scheme by randomly permuting an array with U elements, where the array includes U/T elements for each task.

In some implementations, each batch of training examples includes multiple batches of network inputs corresponding to respective different modalities of the plurality of modalities. This is referred to in FIG. 3 as the “accumulating gradients” scheme 350. That is, as part of the training, at each iteration of the process 200, the system determines a single update to the plurality of parameters of the neural network using multiple batches of network inputs corresponding to respective different modalities of the plurality of modalities. As shown in FIG. 3, each larger batch includes multiple individual batches, i.e., one from each of the three tasks. Thus, at the end of training, because there were 5 training iterations performed, the neural network has been trained on 5 batches from task 1, 5 batches from task 2, and 5 batches from task 3.

In some implementations, prior to training the neural network using the process 200, the system initializes the values of the parameters of the neural network using one or more single-task neural networks. For example, the system can initialize the values of the parameters of the shared self-attention blocks to be equal to trained values of corresponding blocks in a single-task neural network that has already been trained on one of the tasks.

As described above, after training, the neural network can be deployed in any of a variety of ways.

In some implementations, after training, the neural network is only used to process inputs of a single particular one of the multiple modalities. Thus, in these implementations, after the neural network has been trained as described above, i.e., by training the neural network to process respective input sequences corresponding to each of the plurality of modalities, the system can generate a new, single-modality neural network by modifying the architecture. In particular, the system can remove the modality-specific network blocks corresponding to respective modalities that are different from the particular modality. The system also removes the task-specific network blocks that correspond to tasks that are performed on inputs of the respective modalities that are different from the particular modality.

In some of these implementations, after training, the neural network is configured to execute a plurality of machine learning tasks corresponding to the particular modality. Thus, the system keeps, as part of the new task-specific neural network, all of the task-specific network blocks that correspond to tasks that are performed on inputs of the particular modality.

In others of these implementations, after training, the neural network is configured to execute only a single machine learning task corresponding to the particular modality. In these implementations, the system removes all of the task-specific network blocks except for the one(s) that correspond to the single machine learning task.

In other implementations, after training, the neural network is still used to process different inputs of different modalities, i.e., the system deploys the neural network as a multi-task, multi-modality neural network.

In any of the above implementations, after the training described above and prior to deploying the neural network, the system can fine-tune the neural network on 1) additional training data, 2) only the training data for the tasks for which the neural network will be used after training, or 3) both.

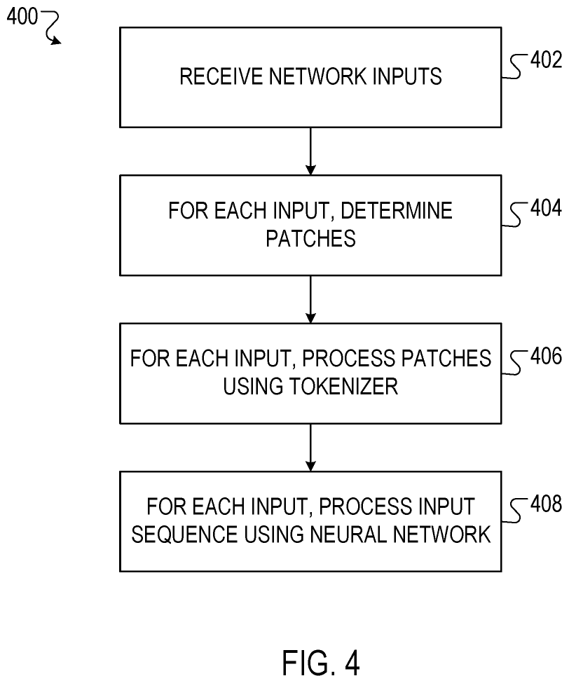

FIG. 4 is a flow diagram of an example process 400 for generating a network output for a new input using a multi-task, multi-modality neural network after training. For convenience, the process 400 will be described as being performed by a system of one or more computers located in one or more locations. For example, a neural network system, e.g., the neural network system 100 of FIG. 1, appropriately programmed, can perform the process 400.

The system receives a respective network input corresponding to each of the plurality of modalities (step 402). In some implementations, for a given modality, the system performs all of the tasks for the modality on all received inputs in parallel. In some other implementations, the system also receives data specifying, for each network input, which task is to be performed on the network input.

The system processes each of the respective network inputs using a neural network to generate respective network outputs for each of the network inputs.

In particular, for each network input, the system determines a plurality of patches of the network input (step 404) and processes the patches using the tokenizer for the corresponding modality as described above to generate an input sequence (step 406). The system then processes the input sequence using the neural network to generate, for at least one of one or more machine learning tasks corresponding to the modality corresponding to the network input, a respective predicted network output (step 408). That is, if the system receives data specifying, for each network input, which task is to be performed on the network input, the system only generates an output for the specified task(s). If not, the system generates, for each network input, an output for each task corresponding to the modality of the network input.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g. use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA: Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor e.g. by the square root of the dimensions of the queries and keys, to implement scaled dot product attention. Thus, for example, an output of the attention mechanism may be determined as

$$softmax ( \frac{{QK}^{T}}{\sqrt{d}} ) V$$

where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks: magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network to process respective input sequences corresponding to each of a plurality of modalities and to generate respective network outputs for the input sequences,
wherein the neural network is configured to execute, for each of the plurality of modalities, one or more machine learning tasks corresponding to the modality,
the training comprising:
obtaining a network input corresponding to a particular modality and comprising a plurality of elements;
determining a plurality of patches of the network input, wherein each patch comprises a different subset of the elements of the network input;
processing the plurality of patches to generate an input sequence comprising a respective input element at each of a plurality of input positions, where some or all of the input elements correspond to respective different patches;
processing the input sequence using the neural network to generate, for at least one of the one or more machine learning tasks corresponding to the particular modality, a respective predicted network output,
wherein the neural network comprises one or more self-attention neural network layers that are each configured to apply a self-attention mechanism to the input sequence or an intermediate representation of the input sequence, and
wherein at least a subset of the self-attention neural network layers are shared across the plurality of modalities; and
determining an update to a plurality of parameters of the neural network according to an error in the respective predicted network outputs.

2. The method of claim 1, wherein the plurality of modalities comprises one or more of an image modality, a video modality, or an audio modality.

3. The method of claim 1, wherein processing the input sequence using the neural network to generate, for at least one of the one or more machine learning tasks corresponding to the particular modality, a respective predicted network output comprises:
processing the input sequence using one or more modality-specific network blocks corresponding to the particular modality to generate a first intermediate representation of the input sequence;
processing the first intermediate representation using one or more shared network blocks to generate a second intermediate representation of the input sequence; and
for each of the at least one machine learning tasks, processing the second intermediate representation using a respective task-specific network block to generate the respective predicted network output for the machine learning task.

4. The method of claim 1, wherein determining an update to a plurality of parameters of the neural network comprises:
identifying a set of training hyperparameters corresponding to the particular modality or the at least one machine learning task; and
determining the update according to the identified set of training hyperparameters.

5. The method of claim 1, wherein at least 50%, at least 60%, at least 70%, at least 80%, or at least 90% of the plurality of parameters of the neural network are shared across the plurality of modalities.

6. The method of claim 1, the training further comprising determining a respective update to the plurality of parameters of the neural network using each of a plurality of batches of network inputs,
wherein for each batch of network inputs, each network input in the batch corresponds to the same modality of the plurality of modalities.

7. The method of claim 6, wherein for each batch of network inputs, each network input in the batch corresponds to the same machine learning task of the one or more machine learning tasks corresponding to the modality of the batch.

8. The method of claim 6, wherein the training comprises determining a same number of updates to the plurality of parameters of the neural network for each of the plurality of modalities.

9. The method of claim 6, wherein the training comprises, for each modality of the plurality of modalities, determining a same number of updates to the plurality of parameters of the neural network for each machine learning task corresponding to the modality.

10. The method of claim 6, wherein:
the training further comprises generating, for each machine learning task corresponding to each modality of the plurality of modalities, one or more batches of network inputs from a training data set corresponding to the machine learning task; and
during training, batches of network inputs are sampled according to a size of the corresponding training data sets from which the batches were generated.

11. The method of claim 1, wherein the training further comprises determining a single update to the plurality of parameters of the neural network using multiple batches of network inputs corresponding to respective different modalities of the plurality of modalities.

12. (canceled)

13. (canceled)

14. (canceled)

15. A system comprising a first neural network that is configured to process input sequences corresponding to a single particular modality of a plurality of modalities and to generate respective outputs for the input sequences,
the first neural network having been trained by performing operations comprising:
training a second neural network to process respective input sequences corresponding to each of the plurality of modalities, the training comprising:
obtaining a network input corresponding to a particular modality and comprising a plurality of elements;
determining a plurality of patches of the network input, wherein each patch comprises a different subset of the elements of the network input;
processing the plurality of patches to generate an input sequence comprising a respective input element at each of a plurality of input positions, where some or all of the input elements correspond to respective different patches;
processing the input sequence using the second neural network to generate, for at least one of one or more machine learning tasks corresponding to the particular modality, a respective predicted network output,
wherein the second neural network comprises one or more self-attention neural network layers that are each configured to apply a self-attention mechanism to the input sequence or an intermediate representation of the input sequence, and
wherein at least a subset of the self-attention neural network layers are shared across the plurality of modalities; and
determining an update to a plurality of parameters of the second neural network according to an error in the respective predicted network outputs; and
modifying an architecture of the second neural network to generate the first neural network.

16. The system of claim 15, wherein modifying an architecture of the second neural network to generate the first neural network comprises removing one or more modality-specific network blocks corresponding to respective modalities that are different from the particular modality.

17. The system of claim 15, wherein the first neural network is configured to execute a plurality of machine learning tasks corresponding to the particular modality.

18. The system of claim 15, wherein the first neural network is configured to execute a single machine learning task corresponding to the particular modality.

19. The system of claim 15, wherein modifying an architecture of the second neural network to generate the first neural network comprises removing one or more task-specific network blocks corresponding to respective tasks for which the first neural network is not configured.

20. The system of claim 15, wherein modifying an architecture of the second neural network to generate the first neural network comprises:
modifying the architecture of the second neural network to generate an initial first neural network; and
fine-tuning a plurality of parameters of the initial first neural network to generate the first neural network.

21. (canceled)

22. (canceled)

23. A method performed by one or more computers, the method comprising:
receiving a respective network input corresponding to each of a plurality of modalities, wherein each network input includes a respective plurality of elements; and
processing the respective network inputs using a neural network to generate respective network outputs for each of the network inputs,
the processing comprising, for each network input:
determining a plurality of patches of the network input, wherein each patch comprises a different subset of the elements of the network input;
processing the plurality of patches to generate an input sequence comprising a respective input element at each of a plurality of input positions, where some or all of the input elements correspond to respective different patches; and
processing the input sequence using the neural network to generate, for at least one of one or more machine learning tasks corresponding to the modality corresponding to the network input, a respective predicted network output,
wherein the neural network comprises one or more self-attention neural network layers that are each configured to apply a self-attention mechanism to the input sequence or an intermediate representation of the input sequence; and
wherein at least a subset of the self-attention neural network layers are shared across the plurality of modalities.

24. (canceled)

25. (canceled)
